(19) United States
(12) Patent Application Publication
(10) Pub. No.: US 2012/0305176 A1
(43) Pub. Date: Dec. 6, 2012

(54) METHOD OF PRODUCING ELECTRONIC MEMBER

(75) Inventors: Nozomi Kimura, Kanagawa (JP); Keisuke Shimizu, Kanagawa (JP)

(73) Assignee: SONY CORPORATION, Tokyo (JP)

(21) Appl. No.: 13/477,560

(22) Filed: May 22, 2012

(30) Foreign Application Priority Data
May 31, 2011 (JP) 2011-121735

(51) Int. Cl. B32B 37/12

(52) U.S. Cl. 156/230

(57) ABSTRACT

A method of producing an electronic member includes: placing a laminated ink at a depression section of an intaglio plate having the depression section, or at a lyophilic part of a lithographic plate having the lyophilic part and a liquid-repellent part, the laminated ink including an electronic material layer and an adhesive material layer laminated in this order from a bottom side of the depression section or the lyophilic part; and transferring the laminated ink to a surface of a substrate directly or after transferring the laminated ink to a blanket temporarily, wherein surface free energy of each of the electronic material layer and the adhesive material layer satisfies relational expressions (1) and (2) as follows.

E2<E3<E1 or E1<E3<E2 (1)

|E1−E2|>|E3−E2| (2)

### BACKGROUND

The technology relates to a method of producing an electronic member including a conductive film, and, for example, to a method of producing an electronic member suitable for production of wiring or a thin-film transistor included in an electronic device such as a touch panel or a display.

Forming a conductive film by using various printing methods is a technique effective at reducing cost of electronic devices such as a touch panel and a display, and research and development thereof have been actively carried out in recent years. Printing methods are used appropriately according to a thickness of wiring desired for various devices. Intaglio printing and planographic printing are very effective as a method of performing pattern printing of wiring having a thickness of tens of micrometers and commonly used for an electronic device.

In ordinary intaglio printing and planographic printing, an ink in use easily comes off a plate, and is desired to have a characteristic not to transform on a substrate serving as a destination of transfer. However, some of inks used for conductive films are unsuitable for the above-described printing. In a case of using such an unsuitable ink, an effort such as adding a polymer to the ink or increasing density of the ink is made in general, so as to provide the ink having the above-described characteristics. Nevertheless, it is difficult to obtain a highly conductive film by these techniques.

For gravure printing, there is a technique in which an ink usually unsuitable for printing is allowed to be patterned by performing printing while drying the ink. However, this technique is not appropriate for printing of a conductive film. This is because, when a change in density of the ink occurs after a nonuniform drying process, a conductive substance condenses unevenly, thereby causing a deterioration in post-printing conductivity of the conductive film.

A currently-available technique capable of avoiding this situation is to perform patterning by forming a hydrophobic part and a liquid-repellent part on a substrate, as described in Japanese Unexamined Patent Application Publication No. 2010-76189, for example.

### SUMMARY

Concerning the technique described in Japanese Unexamined Patent Application Publication No. 2010-76189 however, there is a case where it is difficult to form a film with a pattern different from a conductive film, on the conductive film. Thus, the currently-available technique has such a disadvantage that an electronic member such as wiring and a thin-film transistor of an electronic device like a touch panel or a display is not easy to produce by printing.

It is desirable to provide a method of producing an electronic member capable of being printed by intaglio printing and planographic printing, even when an ink unsuitable for intaglio printing and planographic printing in currently-available methods is used.

A method of producing an electronic member according to an embodiment of the technology includes: placing a laminated ink at a depression section of an intaglio plate having the depression section, or at a lyophilic part of a lithographic plate having the lyophilic part and a liquid-repellent part, the laminated ink including an electronic material layer and an adhesive material layer laminated in this order from a bottom side of the depression section or the lyophilic part; and transferring the laminated ink to a surface of a substrate directly or after transferring the laminated ink to a blanket temporarily, wherein surface free energy of each of the electronic material layer and the adhesive material layer satisfies relational expressions (1) and (2) as follows,

E2<E3<E1 or E1<E3<E2 (1)

|E1−E2|>|E3−E2| (2)

where E1 is surface free energy of the bottom of the depression section or the lyophilic part, E2 is the surface free energy of the electronic material layer, and E3 is the surface free energy of the adhesive material layer.

Here, the relational expression (1) indicates that a hydrophilic-hydrophobic property (a property A) of the bottom of the depression section or the lyophilic part, a hydrophilic-hydrophobic property (a property B) of the electronic material layer, and a hydrophilic-hydrophobic property (a property C) of the adhesive material layer are different from one another. The relational expression (2) indicates that the property B is closer to the property C than to the property A. In other words, the electronic material layer has a property of satisfactory adhesion to the adhesive material layer and satisfactory detachability from the bottom of the depression section or the lyophilic part. The relational expression (3) indicates that the property C is closer to the property B than to the property A. In other words, the adhesive material layer has a property of satisfactory adhesion to the electronic material layer and satisfactory detachability from the bottom of the depression section or the lyophilic part.

In the method according to the embodiment of the technology, the laminated ink, in which the electronic material layer and the adhesive material layer satisfying the relational expressions (1) and (2) are laminated, is transferred to the surface of the substrate directly or after being transferred to the blanket temporarily, through use of the intaglio plate or the lithographic pate. This makes it possible to print the laminated ink including the electronic material layer onto the substrate without bleeding, by using the property of the adhesive material layer, even when the electronic material layer has a property unsuitable for intaglio printing and planographic printing.

Incidentally, it is preferable that surface free energy of the blanket, as well as the surface free energy of each of the electronic material layer and the adhesive material layer satisfy the following relational expression (4).

|E1−E2|>|E4−E3|>|E3−E2| (4)

E4: Surface free energy of the blanket

Here, the relational expression (4) indicates that adhesion between the blanket and the adhesive material layer is higher than adhesion between the electronic material layer and the bottom of the depression section or the liquid-repellent part, and lower than adhesion between the electronic material layer and the adhesive material layer. It is to be noted that it is possible to improve printability by appropriately controlling, hardness of the blanket, degree of swelling due to a solvent of the blanket, print speed, and the like.

In the placing of the laminated ink according to the embodiment of the technology, the laminated ink may be formed by disposing the adhesive material layer on the electronic material layer, after the electronic material layer is formed by disposing a liquid electronic material layer at the depression section of the intaglio plate or at the lyophilic part of the lithographic plate and drying the disposed liquid electronic material layer, for example. It is possible to avoid print bleeding due to the electronic material layer, in this case as well.

Further, in the placing of the laminated ink according to the embodiment of the technology, the laminated ink may be formed by disposing a composite ink in which an electronic material and an adhesive material are combined, at the depression section of the intaglio plate or at the lyophilic part of the lithographic plate, and separating the composite ink into a liquid electronic material layer and the adhesive material layer, for example. It is possible to avoid print bleeding due to the electronic material layer, in this case as well.

In addition, according to the embodiment of the technology, it is possible to secure transferability with the adhesive material layer, without optimizing viscosity of the electronic material layer. This makes it possible to print the electronic material layer on the substrate without bleeding, without impairing original properties of the material, even when the electronic material layer is a solution containing one or more kinds of material selected from oxide-based transparent conductive material, metal, conductive polymer, and nano-carbon, or the solution being dried. It is to be noted that the oxide-based transparent conductive material includes, for example, ITO (Indium Tin Oxide), GZO (Gallium dope Zinc Oxide), ZnO, or the like. The metal includes, for example, Ag (silver), Cu (copper), or the like.

Moreover, according to the embodiment of the technology, the electronic material layer may be a conductive layer or a semiconductor material layer, for example. The conductive layer may be a transparent conductive layer or a non-transparent conductive layer. Here, the transparent conductive layer is made of, for example, an oxide-based transparent conductive material such as ITO, GZO, or ZnO. Further, the non-transparent conductive layer is made of, for example, a non-transparent conductive material such as Ag or Cu. The semiconductor material layer is made of, for example, an organic semiconductor or an oxide semiconductor. When the electronic material layer is made of the oxide-based transparent conductive material, the electronic material layer printed on the substrate may be used, for example, as wiring of an electronic device such as a touch panel or a display. When the electronic material layer is the semiconductor material layer, the electronic material layer printed on the substrate may be used, for example, a thin-film transistor included in an electronic device such as a touch panel or a display.

It is to be noted that when the electronic material layer is the transparent conductive layer, the adhesive material layer is desired to be transparent. Examples of transparent materials applicable as the adhesive material layer include PVDF, polycarbonate, polystyrene, EVA, and the like.

When the electronic material layer printed on the substrate is used, for example, as wiring or a thin-film transistor included in an electronic device such as a touch panel or a display, it is desirable that the electronic material layer and the adhesive material layer each have a nanometer-order film thickness, for example.

According to the method of producing the electronic member of the embodiment of the technology, the laminated ink in which the electronic material layer and the adhesive material layer are laminated is provided as an ink used for intaglio printing and planographic printing. Therefore, it is possible to print the electronic material layer which is unsuitable for intaglio printing and planographic printing in currently-available methods, by making the adhesive material layer have a property suitable for the intaglio printing and planographic printing. As a result, it is possible to use the laminated ink including the electronic material layer printed with the intaglio printing or planographic printing as, for example, an electronic member such as wiring or a thin-film transistor included in an electronic device like a touch panel or a display.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIGS. 1A to 1E are cross-sectional diagrams illustrating an example of a method of producing an electronic member according to a first embodiment.

FIGS. 2A to 2C are cross-sectional diagrams illustrating another example, different from the method in FIGS. 1A to 1E.

FIGS. 3A to 3E are cross-sectional diagrams illustrating an example of a method of producing an electronic member according to a second embodiment.

FIGS. 4A and 4B are cross-sectional diagrams illustrating another example, different from the method in FIGS. 3A to 3E.

### DETAILED DESCRIPTION

Embodiments of the technology will be described below in detail with reference to the drawings. It is to be noted that the description will be provided in the following order.

1. First embodiment
An example in which an electronic member is produced by intaglio printing

2. Second embodiment
An example in which an electronic member is produced by planographic printing

3. Example

### 1. FIRST EMBODIMENT

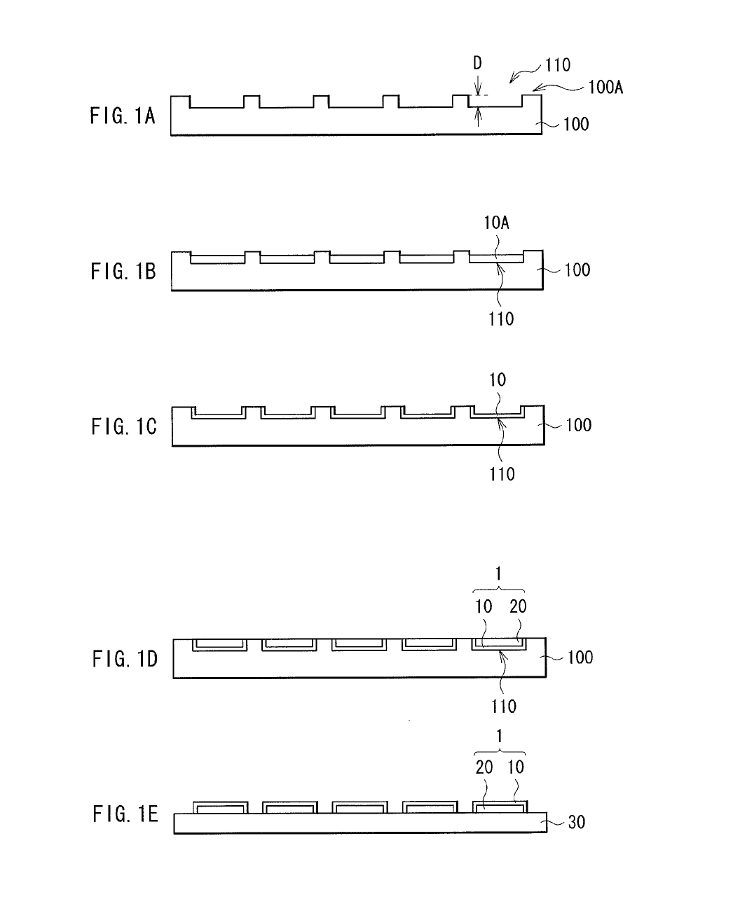

FIGS. 1A to 1E illustrate an example of a method of producing an electronic member according to the first embodiment. In the present embodiment, an electronic member is produced by printing using an intaglio plate 100.

First, the intaglio plate 100 will be described before describing printing of the electronic member. The intaglio plate 100 includes, for example, depression sections 110 on a plate surface 100A as illustrated in FIG. 1A. The intaglio plate 100 may be shaped like a flat board as illustrated in FIG. 1A, or shaped like a drum although it is not illustrated. The depression sections 110 are shaped to have a pattern suitable for an intended use of the electronic member. For example, when the electronic member is used as wiring, the depression sections 110 form a shape corresponding to the shape of the wiring. Alternatively, for instance, when the electronic member is used as a channel layer of a TFT (Thin Film Transistor), the depression sections 110 form a shape corresponding to the shape of the channel layer.

The depression sections 110 vary in depth D from case to case, as will be described below. For example, in a case where the electronic member is used as wiring included in an electronic device such as a touch panel or a display, when the electronic member is configured using a laminate including a wiring layer that functions as wiring, the depth D of each of the depression sections 110 is equal to the thickness of the laminate. Here, when an upper limit to a wiring thickness acceptable for the electronic device is less than 1 μm (namely, on the order of nanometers), it is desirable that the depth D of each of the depression sections 110 also be less than 1 μm.

This also applies to a case where the electronic member is used as a channel layer of a TFT. For example, in the case of using the electronic member as the channel layer of the TFT, when the electronic member is configured using a laminate including the channel layer, the depth D of each of the depression sections 110 is equal to the thickness of the laminate. Here, when an upper limit to a channel layer thickness acceptable for an electronic device is equal to or less than hundreds of nanometers, it is desirable that the depth D of each of the depression sections 110 also be equal to or less than hundreds of nanometers.

The plate surface 100A of the intaglio plate 100 is configured using a material having high hardness such as glass and stainless steel, for example. The material of an ink to be applied to the plate surface 100A is selected considering surface free energy of the plate surface 100A. In some cases, the material of the plate surface 100A is selected considering surface free energy of the ink to be applied to the plate surface 100A. As the ink to be applied to the plate surface 100A, there are, for example, a liquid ink containing an electronic material and an ink containing an adhesive material.

The electronic material refers to a material used for an electronic device, such as a conductive material or a semiconductor material. The conductive material is, for example, one or more kinds of material selected from oxide-based transparent conductive material, metal, conductive polymer, and nano-carbon. The oxide-based transparent conductive material includes, for example, ITO, GZO, ZnO, or the like. The metal includes, for example, Ag, Cu, or the like. Optical transparency of the conductive material varies depending on an intended use. When the conductive material is used, for example, as a detection electrode of a touch panel or an electrode of a transmission-type display panel, it is desirable that the conductive material be a material having high optical transparency (e.g., ITO or a conductive polymer). When the conductive material is used, for example, as a reflecting electrode of a reflection type or semi-transmissive type display panel, it is preferable that the conductive material be a metallic material with low optical transparency (e.g., Ag). The semiconductor material is, for example, an organic semiconductor, an oxide semiconductor, or the like.

The adhesive material has high adhesion to the above-described electronic material, as wells as high detachability from the plate surface 100A. Here, an adhesive material layer is not limited in particular, as long as it satisfies relational expressions of surface free energy in realizing effects of the present technology. However, when transparency is desired for a target device, it is desirable that an electronic material layer and the adhesive material layer have transparency. Examples of a transparent material applicable as the adhesive material layer include PVDF, polycarbonate, polystyrene, and EVA. When the adhesive material layer is used as an insulating layer of the electronic material layer that is a conductive layer or a semiconductor material layer, it is desirable that the adhesive material layer be made of an insulating material. In this way, the adhesive material is selected as appropriate according to a purpose of a final form.

Here, each of the plate surface 100A, a dried layer (the electronic material layer) of the liquid ink (the liquid electronic material layer) containing the electronic material, and the ink (the adhesive material layer) containing the adhesive material has surface free energy. The surface free energy at least satisfies the following expressions (1) and (2), and preferably meets all of the following relational expressions (1) to (3).

E2<E <E1 or E1<E3<E2 (1)

|E1−E2|>|E3−E2| (2)

|E1−E3|>|E3−E2| (3)

E1: Surface free energy of the plate surface 100A

E2: Surface free energy of the electronic material layer

E3: Surface free energy of the adhesive material layer

Here, the relational expression (1) indicates that a hydrophilic-hydrophobic property (a property A) of the plate surface 100A, a hydrophilic-hydrophobic property (a property B) of the electronic material layer, and a hydrophilic-hydrophobic property (a property C) of the adhesive material layer are different from one another. The relational expression (2) indicates that the property B is closer to the property C than to the property A. In other words, the electronic material layer has a property of satisfactory adhesion to the adhesive material layer and satisfactory detachability from the plate surface 100A. The relational expression (3) indicates that the property C is closer to the property B than to the property A. In other words, the adhesive material layer has a property of satisfactory adhesion to the electronic material layer and satisfactory detachability from the plate surface 100A.

The viscosity of the ink applied to the plate surface 100A is adjusted considering physical properties of the intaglio plate 100, an intended use of the electronic member, and the like. The viscosity of the ink suitable for intaglio printing is usually 0.5 Pa·S or more and 50 Pa·S or less. The viscosity of the liquid electronic material layer is adjustable by adding a polymer or regulating the amount of the electronic material added. However, there is a possibility that as a result of such an adjustment, deterioration in property of the electronic material layer might occur when the liquid electronic material layer is dried. Therefore, it is preferable that the liquid electronic material layer have a viscosity by which a property desired for the electronic material layer when dried is obtained. When the viscosity of the liquid electronic material layer is set from such a viewpoint however, there is a case where the viscosity of the liquid electronic material layer is extremely lower than an ink viscosity suitable for intaglio printing. In the present embodiment however, the viscosity of the liquid electronic material layer is no longer disadvantageous, by employing a printing method which will be described later. On the other hand, it is preferable that the adhesive material layer have an ink viscosity suitable for intaglio printing. It is to be noted that when a solvent is used for the adhesive material layer, the solvent is, preferably, a material not allowing easy dissolution of the electronic material layer.

Next, the method of producing the electronic member in the present embodiment will be described with reference to FIGs. lA to 1E, by way of example.

First, the intaglio plate 100 having the depression sections 110 on the plate surface 100A is prepared (FIG. 1A). Next, the liquid ink containing the above-described electronic material is dropped onto the plate surface 100A and subsequently, a squeegee (not illustrated), for example, is run on the plate surface 100A. As a result, a liquid electronic material layer 10A is formed in (fills, for example) each of the depression sections 110 (FIG. 1B). Here, the liquid electronic material layers 10A in the depression sections 110 next to each other are space-separated. It is to be noted that the type of the squeegee is not limited in particular. The squeegee may be of any type which is appropriate in terms of the solvent, wettability, and acidity of the ink.

Next, the liquid electronic material layer 10A in each of the depression sections 110 is dried to form a dry electronic material layer 10 in the depression section 110 (FIG. 1C). Here, the electronic material layer 10 is formed to cover all of inner walls of the depression section 110 as illustrated in FIG. 1C, for example. It is to be noted that depending on the wettability of the inner walls of the depression section 110, the electronic material layer 10 may be formed only in the bottom of the depression section 110.

The thickness of the electronic material layer 10 varies depending on an intended use of the electronic material layer 10. When the electronic material layer 10 is used, for example, as a detection electrode of a touch panel or an electrode of a transmission-type display panel, the electronic material layer 10 has a nanometer-order thickness (typically, a thickness of tens of nanometers or more and hundreds of nanometers or less). When the electronic material layer 10 is used, for example, as a channel layer of a TFT, the electronic material layer 10 has a nanometer-order thickness (typically, a thickness of a few nanometers or more and hundreds of nanometers or less).

It is to be noted that when a thickness desired for the electronic material layer 10 is not achieved by merely applying the liquid electronic material layer 10A once and drying the same, application and drying of the liquid electronic material layer 10A are repeated until a thickness desired for the electronic material layer 10 is achieved.

Next, the liquid ink containing the above-described adhesive material is dropped onto the plate surface 100A and subsequently, the squeegee (not illustrated), for example, is run on the plate surface 100A. As a result, an adhesive material layer 20 is formed in (fills, for example) each of the depression sections 110, and thereby a laminated ink 1 including the electronic material layer 10 and the adhesive material layer 20 is formed (FIG. 1D). Here, the laminated inks 1 in the depression sections 110 next to each other are space-separated.

The thickness of the adhesive material layer 20 depends on the depth D of the depression section 110 and the thickness of the electronic material layer 10. When the laminated ink 1 is used for an electronic device, the thickness of the adhesive material layer 20 is, for example, on the order of hundreds of nanometers or more and a few micrometers or less.

The laminated ink 1 has, for example, a configuration in which faces except a top face (i.e., side faces and a bottom face) of the adhesive material layer 20 are covered by the electronic material layer 10, as illustrated in FIG. 1D. It is to be noted that there is a case where the laminated ink 1 has a two-layer structure in which the electronic material layer 10 and the adhesive material layer 20 are simply laminated, depending on the wettability of the inner walls of the depression section 110.

Next, the plate surface 100A is pressed against a surface of a substrate 30. As a result, the laminated ink 1 is transferred (printed) onto the surface of the substrate 30, as illustrated in FIG. 1E. Here, the substrate 30 is a glass substrate, a silicon substrate, a PET substrate, or the like, for example. The substrate 30 may be a single layer or a laminate. When the intaglio plate 100 is made of a material without flexibility, it is preferable that the substrate 30 be flexible.

The laminated ink 1 has a configuration in which faces except a face being in contact with the substrate 30 (i.e., side faces and a top face) of the adhesive material layer 20 are covered with the electronic material layer 10. It is to be noted that there is a case where the laminated ink 1 has a configuration in which the adhesive material layer 20 and the electronic material layer 10 are laminated in this order from the substrate 30 side, depending on the wettability of the inner walls of the depression section 110. In this way, the electronic member made of the laminated ink 1 is produced.

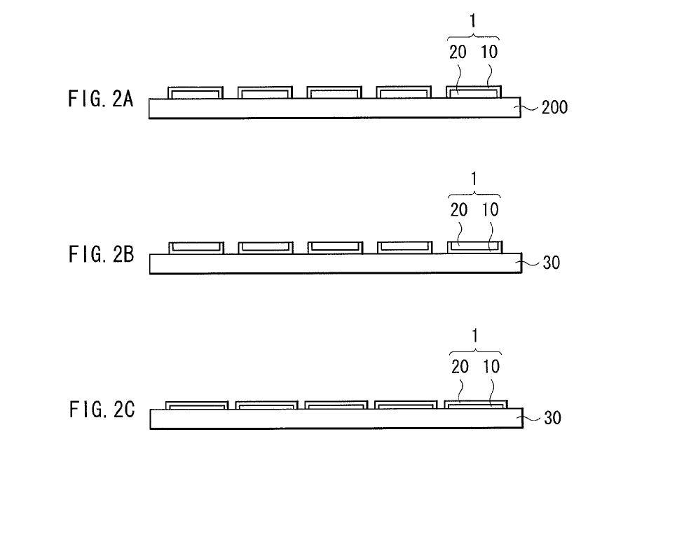

It is to be noted that, instead of direct printing in which the laminated ink 1 is directly transferred to the surface of the substrate 30, there may be performed offset printing in which the laminated ink 1 is transferred to the surface of the substrate 30 after being transferred to a blanket temporarily. For instance, the plate surface 100A is pressed against a surface of a blanket 200. As a result, the laminated ink 1 is transferred (printed) onto the surface of the blanket 200, as illustrated in FIG. 2A.

It is preferable that surface free energy of the blanket 200, as well as the surface free energy of each of the plate surface 100A, the electronic material layer 10, and the adhesive material layer 20 satisfy the following relational expression (4).

|E1−E2|>|E4−E3|>|E3−E2| (4)

E4: Surface free energy of the blanket 200

Here, the relational expression (4) indicates that adhesion between the blanket 200 and the adhesive material layer 20 is higher than adhesion between the electronic material layer 10 and the plate surface 100A, and lower than adhesion between the electronic material layer 10 and the adhesive material layer 20. It is to be noted that printability may be improved by appropriately controlling hardness of the blanket 200, degree of swelling due to a solvent of the blanket 200, print speed, and the like.

Subsequently, the blanket 200 in a state in which the surface provided with the laminated ink 1 is directed to the substrate 30 is pressed against the surface of the substrate 30. As a result, the laminated ink 1 is transferred (printed) onto the surface of the substrate 30 as illustrated in FIG. 2B.

As illustrated in FIG. 2B, the laminated ink 1 has a configuration vertically opposite to the configuration illustrated in FIG. 1E. In other words, the laminated ink 1 has, for example, a configuration in which faces except a top face (i.e., side faces and a bottom face) of the adhesive material layer 20 are covered with the electronic material layer 10. It is to be noted that there is a case where the laminated ink 1 has a configuration in which the electronic material layer 10 and the adhesive material layer 20 are laminated in this order from the substrate 30 side, depending on the wettability of the inner walls of the depression section 110.

Here, when the viscosity of the adhesive material layer 20 is high to some extent, the laminated ink 1 has the above-described configuration. However, when the viscosity of the adhesive material layer 20 is not high enough, the adhesive material layer 20 breaks sidewalls of the electronic material layer 10, thereby covering the electronic material layer 10 as illustrated in FIG. 2C. When the laminated ink 1 is in such a configuration, the electronic material layer 10 is insulated and separated from outside by the adhesive material layer 20, and the adhesive material layer 20 functions as a passivation layer.

Next, effects of the method of producing the electronic member in the present embodiment will be described.

In the present embodiment, the electronic material layer 10 and the adhesive material layer 20 satisfying the above-described relational expressions (1) and (2) are laminated in the laminated ink 1. The laminated ink 1 is transferred to the surface of the substrate 30 directly or, after being transferred to the blanket 200, through use of the intaglio plate 100. Thus, it is possible to print the laminated ink 1 including the electronic material layer 10 on the substrate 30 without bleeding, by taking advantage of the property of the adhesive material layer 20, even when the electronic material layer 10 has a property unsuitable for intaglio printing. As a result, it is possible to use the laminated ink 1 including the electronic material layer 10 printed by the intaglio printing, as an electronic member such as wiring or a thin-film transistor included in an electronic device like a touch panel or a display, for example.

### 2. SECOND EMODIMENT

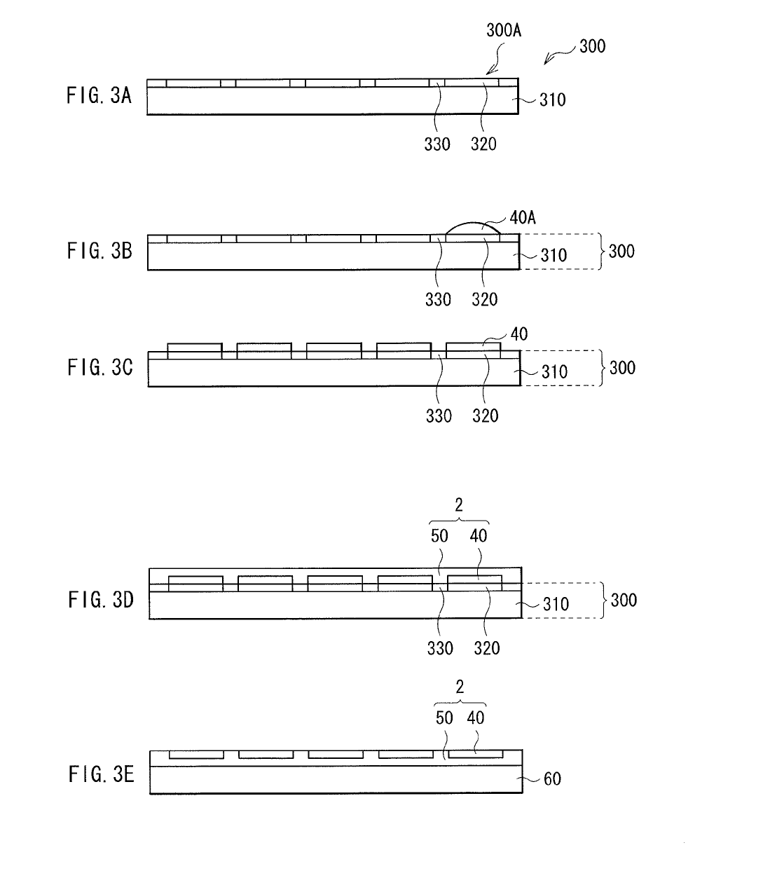

FIGS. 3A to 3E illustrate an example of a method of producing an electronic member according to the second embodiment. In the present embodiment, the electronic member is produced using a lithographic plate 300.

First, the lithographic plate 300 will be described before description about printing of the electronic member. The lithographic plate 300 has, for example, lyophilic parts 320 and liquid-repellent parts 330 on a plate surface 300A as illustrated in FIG. 3A. The lithographic plate 300 may be shaped like a flat substrate as illustrated in FIG. 3A, or shaped like a drum although it is not illustrated. The lyophilic parts 320 are parts on which an ink is to be placed, and form a pattern suitable for an intended use of the electronic member. For example, when the electronic member is used as wiring, the lyophilic parts 320 form a shape corresponding to the shape of the wiring. When the electronic member is used as a channel layer of a TFT (Thin Film Transistor), for instance, the lyophilic parts 320 form a shape corresponding to the shape of the channel layer. The liquid-repellent parts 330 are parts on which the ink is not to be placed (the ink does not stay).

The material of the ink to be applied to the plate surface 300A is selected considering surface free energy of the lyophilic part 320. In some cases, the material of the lyophilic part 320 is selected considering surface free energy of the ink to be applied to the plate surface 300A. As the ink to be applied to the plate surface 300A, there are the liquid ink containing the electronic material in the above-described embodiment and the ink containing the adhesive material described in the above-described embodiment. It is to be noted that the electronic material and the adhesive material are the same materials as those of the above-described embodiment.

Here, surface free energy of each of the lyophilic part 320, an electronic material layer, and an adhesive material layer at least satisfies the following relational expressions (1) and (2), and preferably, satisfies all of the following relational expressions (1) to (3).

E2<E <E1 or E1<E3<E2 (1)

|E1−E2|>|E3−E2| (2)

|E1−E3|>|E3−E2| (3)

E1: Surface free energy of the lyophilic part 320

E2: Surface free energy of the electronic material layer

E3: Surface free energy of the adhesive material layer

Here, the above relational expressions (1) and (2) indicate that a hydrophilic-hydrophobic property (a property A) of the lyophilic part 320 and a hydrophilic-hydrophobic property (a property B) of the adhesive material layer are different from each other. Further, the above relational expressions (1) and (2) also indicate that the hydrophilic-hydrophobic property of the electronic material layer is closer to the property B than to the property A. In other words, the adhesive material layer has a property of satisfactory adhesion to the electronic material layer and satisfactory detachability from the lyophilic part 320.

The viscosity of the ink to be applied to the plate surface 300A is adjusted considering physical properties of the lithographic plate 300, an intended use of the electronic member, and the like. The viscosity of the ink suitable for planographic printing is usually 200 Pa·S or more and 1000 Pa·S or less. The viscosity of the liquid electronic material layer is adjustable by adding a polymer or regulating the amount of the electronic material added. However, there is a possibility that as a result of such an adjustment, deterioration in property of the electronic material layer might occur when the liquid electronic material layer is dried. Therefore, it is preferable that the liquid electronic material layer have a viscosity by which a property desired for the electronic material layer when dried is obtained. When the viscosity of the liquid electronic material layer is set from such a viewpoint however, there is a case where the viscosity of the liquid electronic material layer is extremely lower than an ink viscosity suitable for the planographic printing. In the present embodiment however, since a printing method to be described later is employed, the viscosity of the liquid electronic material layer is no longer disadvantageous. Meanwhile, it is preferable that the viscosity of the adhesive material layer be an ink viscosity suitable for the planographic printing. It is to be noted that when a solvent is used in the adhesive material layer, the solvent is, preferably, a material not allowing easy dissolution of the electronic material layer.

Next, the example of the method of producing the electronic member of the present embodiment will be described with reference to FIGS. 3A to 3E.

First, the lithographic plate 300 having the lyophilic parts 320 and the liquid-repellent parts 330 on the plate surface 300A is prepared (FIG. 3A). Next, the liquid ink containing the electronic material above described is dropped onto the plate surface 300A. As a result, liquid electronic material layers 40A are formed on the lyophilic parts 320 selectively (FIG. 3B). The liquid electronic material layers 40A on the lyophilic parts 320 next to each other are space-separated by the liquid-repellent parts 330.

Next, the liquid electronic material layers 40A on the lyophilic parts 320 are dried, and thereby dry electronic material layers 40 are formed on the lyophilic parts 320 (FIG. 3C). Here, the electronic material layer 40 is formed to cover the entire surface of each of the lyophilic parts 320 as illustrated in FIG. 3C, for example.

The thickness of the electronic material layer 40 varies depending on an intended use of the electronic material layer 40. When the electronic material layer 40 is used, for example, as a detection electrode of a touch panel or an electrode of a transmission-type display panel, the thickness of the electronic material layer 40 has a nanometer-order thickness (typically, a thickness of tens of nanometers or more and hundreds of nanometers or less). When being used as a channel layer of a TFT, for example, the electronic material layer 40 has a nanometer-order thickness (typically, a thickness of a few nanometers or more and hundreds of nanometers or less).

Next, the liquid ink containing the adhesive material described above is dropped onto the surface including the electronic material layers 40 and the liquid-repellent parts 330. As a result, an adhesive material layer 50 is formed on the entire surface or in a predetermined region of the surface, and thereby a laminated ink 2 including the electronic material layers 40 and the adhesive material layer 50 is formed (FIG. 3D). When the laminated ink 2 is used for an electronic device, the thickness of the adhesive material layer 50 is, for example, on the order of hundreds of nanometers or more and a few micrometers or less. The laminated ink 2 has, for example, a configuration in which faces except a bottom face (i.e., side faces and a top face) of each of the electronic material layers 40 are covered with the adhesive material layer 50, as illustrated in FIG. 3D.

The plate surface 300A is then pressed against a surface of a substrate 60. As a result, the laminated ink 2 is transferred (printed) onto the surface of the substrate 60, as illustrated in FIG. 3E. Here, the substrate 60 is, for example, a glass substrate, a silicon substrate, a PET substrate, or the like. The substrate 60 may be a single layer, or a laminate. When the lithographic plate 300 is made of a material without flexibility, it is preferable that the substrate 60 be flexible.

The laminated ink 2 has a configuration in which faces except a top face (i.e., side faces and a bottom face) of each of the electronic material layers 40 are covered with the adhesive material layer 50. The electronic member made of the laminated ink 2 is produced in this way.

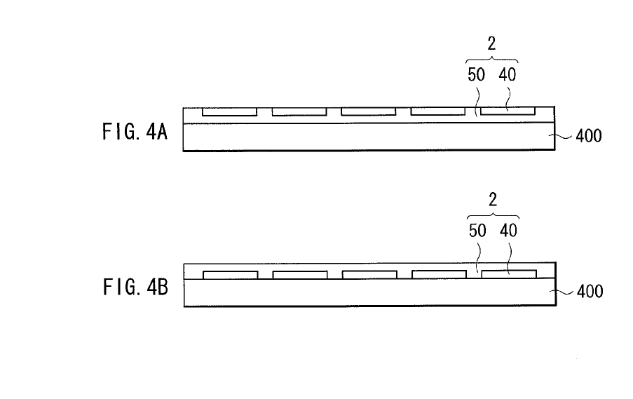

It is to be noted that, instead of direct printing in which the laminated ink 2 is directly transferred to the surface of the substrate 60, there may be performed offset printing in which the laminated ink 2 is transferred to the surface of the substrate 60 after being transferred to a blanket temporarily. For example, the plate surface 300A is pressed against a surface of a blanket 400. As a result, the laminated ink 2 is transferred (printed) onto the surface of the blanket 400 as illustrated in FIG. 4A. Subsequently, the blanket 400 in a state in which the surface provided with the laminated ink 2 is directed to the substrate 60, is pressed against the surface of the substrate 60. As a result, the laminated ink 2 is transferred (printed) onto the surface of the substrate 60 as illustrated in FIG. 4B.

As illustrated in FIG. 4B, the laminated ink 2 has a configuration vertically opposite to the configuration illustrated in FIG. 3E. In other words, the laminated ink 2 has, for example, a configuration in which faces except a bottom face (i.e., side faces and a top face) of the electronic material layer 40 are covered with the adhesive material layer 50.

Next, effects of the method of producing the electronic member in the present embodiment will be described.

In the present embodiment, the electronic material layer 40 and the adhesive material layer 50 satisfying the relational expressions (1) and (2) are laminated in the laminated ink 2. Through the use of the lithographic plate 300, the laminated ink 2 is transferred to the surface of the substrate 60 directly or after being transferred to the blanket 400 temporarily. Thus, it is possible to print the laminated ink 2 including the electronic material layer 40 on the substrate 60 without bleeding, by taking advantage of the property of the adhesive material layer 50, even when the electronic material layer 40 has a property unsuitable for planographic printing. As a result, the laminated ink 2 including the electronic material layer 40 printed by the planographic printing is allowed to be used as an electronic member for wiring or a thin-film transistor included in an electronic device such as a touch panel or a display, for example.

### 3. EXAMPLE

Next, an Example of the method of producing the electronic member of the first embodiment will be described.

A liquid ink (an ink A) used for the electronic material layer 10 and an ink (an ink B) used for the adhesive material layer 20 were prepared as follows.

### (Ink A)

5 g of distilled water and 6 g of a commercially available PEDOT/PSS water solution (Baytron PHCV4 manufactured by H. C. Starck) were added to 30 mg of SWCNT (FH-P manufactured by Meijo Nano Carbon Co., Ltd.), which was then treated using a homogenizer for five minutes. Furthermore, 50 ml of ethanol was added thereto, and a treatment with the homogenizer was carried out for 20 minutes. After the solution thus obtained was treated with a centrifuge (5000 rpm, for one hour), only a supernatant was taken out, and thereby the ink was obtained.

### (Ink B)

20 ml of NMP (N-methylpirroridone) was added to 0.4 g of PVdF (Mw. 534000 manufactured by Sigma-Aldrich) and dissolved, and thereby a 20 wt % solution was obtained.

Next, the ink A was dropped onto a glass intaglio plate (with a pattern depth of 20 μm, and various widths as this was a test pattern), and depression sections were filled with the ink A by using a metal squeegee. The ink A was then dried. The inside of each of the depression sections was then filled with the ink B by using the squeegee. Next, through use of a gravure press, the glass intaglio plate and a PET substrate affixed onto a roll were pressed against each other while being moved, and thereby a laminated ink including the ink A and the ink B was transferred onto the PET substrate. After printing, a transmittance and a resistance value of a pattern part were measured, and as a result, the transmittance was 92% T, and the resistance value was 650 ohm/sq.

The technology has been described using the embodiments and the Example, but is not limited to the embodiments and the Example, and may be variously modified.

### (Modification 1)

For example, the laminated ink may be formed as follows. A composite ink in which the above-described electronic material and the above-described adhesive material are combined is placed in the depression sections 110 of the intaglio plate 100 or on the lyophilic parts 320 of the lithographic plate 300, and the placed composite ink is separated into a liquid electronic material layer and an adhesive material layer to thereby form the electronic material layer. It is possible to avoid print bleeding due to the electronic material layer, in this case as well. It is to be noted, in this case, unlike the embodiments and the Example described above, the laminated ink in which the electronic material layer and the adhesive material layer are laminated is formed after the composite ink is placed on the surface of the plate.

An example of the printing method using the composite ink will be described below.

### (Case 1)

For instance, first, there is prepared a composite ink in which an organic semiconductor material and a polymer material are dissolved in a solvent c, and a particulate material is dispersed in the solvent c. Here, the organic semiconductor material is a low-molecule organic semiconductor material or a polymer organic semiconductor material. Examples of the polymer material include insulating materials such as polystyrene and polymethyl methacrylate. The solvent c sufficiently dissolves the organic semiconductor material and the polymer material, and has high dispersibility of the particulate material. The particulate material is added to control viscosity and thixotropy in the composite ink, and is made of inorganic fine particles or organic fine particles. Examples of the inorganic fine particles include silica and alumina Examples of the organic fine particles include polystyrene and polyethylene.

Next, the composite ink is dropped onto the plate surface 100A of the intaglio plate 100, and printed on the substrate 30. Alternatively, the composite ink is dropped onto the plate surface 300A of the lithographic plate 300, and printed on the substrate 60. Still alternatively, the composite ink is printed on the substrate 30 or the substrate 60, after being transferred to the blanket 200 or the blanket 400 temporarily. Subsequently, the solvent in the composite ink is removed by heating. Here, the composite ink is solidified by removing the solvent, and thereby the organic semiconductor material and the polymer material in the composite ink are separated. In this way, it is possible to print a semiconductor composite layer in which an organic semiconductor material layer and a polymer material layer are laminated.

### (Case 2)

For instance, at first, there is prepared a composite ink in which two kinds of semiconductor materials and an insulating material which is less conductive than these semiconductor materials are dissolved in a solvent. Here, examples of the two kinds of semiconductor materials include organic semiconductor materials such as acene compound, and inorganic semiconductor materials such as silicon. Examples of the insulating material include an organic insulating material and silicon oxide.

Next, the composite ink is dropped onto the plate surface 100A of the intaglio plate 100, and printed on the substrate 30. Alternatively, the composite ink is dropped on the plate surface 300A of the lithographic plate 300, and printed on the substrate 60. Still alternatively, the composite ink is printed on the substrate 30 or the substrate 60 after being transferred to the blanket 200 or the blanket 400 temporarily. Subsequently, the solvent in the composite ink is removed by heating. Here, the composite ink is solidified by removing the solvent, and the two kinds of semiconductor materials and the insulating material in the composite ink are separated. In this way, it is possible to print a semiconductor composite layer in which an insulating material layer is interposed between two kinds of semiconductor material layers.

### (Modification 2)

Further, in the embodiments and the Example described above, accuracy of pattern printing may be improved by controlling surface wettability of the plate, for example. For instance, as for the ink A used in the example, the ink A dries uniformly in the depression sections of the plate and variations among the electronic material layers after the printing are reduced, when the plate is hydrophilic.

### (Modification 3)

Furthermore, in the embodiments and the Example described above, for example, there are important times, namely, the time between drying the ink used for the liquid electronic material layer after application of the ink to the plate and filling the ink, and the time between filling the ink used for the adhesive material layer and printing. These times are selected as appropriate, based on the selected conductive material, resin, solvent, printing plate, printing method, and the like. It is preferable not only to control these times precisely, but also to control the temperature of the substrate as well as atmosphere.

### (Modification 4)

Moreover, in the embodiments and the Example, a pressure at the time of printing also is not limited in particular, for example. It is desirable to select suitable conditions, in view of the thickness of the pattern, film thicknesses, detachability between the conductive layer and the plate (a difference in surface energy), and adhesion between the adhesive material layer and the substrate (a difference in surface energy). Further, some contrivance of currently-available printing techniques may be used in various processes including a process of drying the ink, a process of transfer from the plate to the blanket, a process of transfer from the plate to the substrate, and a process of transfer from the blanket to the substrate. For example, it is conceivable to promote detachment of the adhesive material layer from the plate by heating the plate, to adjust the degree of absorption of the ink into the blanket, or to suppress swelling of the blanket by using a microwave.

Thus, it is possible to achieve at least the following configurations from the above-described example embodiments and the modifications of the disclosure.
(1) A method of producing an electronic member, the method including:

placing a laminated ink at a depression section of an intaglio plate having the depression section, or at a lyophilic part of a lithographic plate having the lyophilic part and a liquid-repellent part, the laminated ink including an electronic material layer and an adhesive material layer laminated in this order from a bottom side of the depression section or the lyophilic part; and

transferring the laminated ink to a surface of a substrate directly or after transferring the laminated ink to a blanket temporarily,

wherein surface free energy of each of the electronic material layer and the adhesive material layer satisfies relational expressions (1) and (2) as follows,

E2<E3<E1 or E1<E3<E2 (1)

|E1−E2|>|E3−E2| (2)

where E1 is surface free energy of the bottom of the depression section or the lyophilic part, E2 is the surface free energy of the electronic material layer, and E3 is the surface free energy of the adhesive material layer.
(2) The method of producing an electronic member according to (1), wherein in the placing of the laminated ink, the laminated ink is formed by disposing the adhesive material layer on the electronic material layer, after the electronic material layer is formed by disposing a liquid electronic material layer at the depression section of the intaglio plate or at the lyophilic part of the lithographic plate, and drying the disposed liquid electronic material layer.
(3) The method of producing an electronic member according to (2), wherein the liquid electronic material layer is made of a solution containing one or more kinds of material selected from oxide-based transparent conductive material, metal, conductive polymer, and nano-carbon.
(4) The method of producing an electronic member according to any one of (1) to (3), wherein the electronic material layer is a conductive layer or a semiconductor material layer.
(5) The method of producing an electronic member according to (4), wherein the adhesive material layer is made of an insulating material.
(6) The method of producing an electronic member according to (4), wherein the electronic material layer and the adhesive material layer have transparency.
(7) The method of producing an electronic member according to any one of (1) to (6), wherein the electronic material layer and the adhesive material layer each have a nanometer-order film thickness.

The disclosure contains subject matter related to that disclosed in Japanese Priority Patent Application JP 2011-121735 filed in the Japan Patent Office on May 31, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A method of producing an electronic member, the method comprising:
placing a laminated ink at a depression section of an intaglio plate having the depression section, or at a lyophilic part of a lithographic plate having the lyophilic part and a liquid-repellent part, the laminated ink including an electronic material layer and an adhesive material layer laminated in this order from a bottom side of the depression section or the lyophilic part; and
transferring the laminated ink to a surface of a substrate directly or after transferring the laminated ink to a blanket temporarily,
wherein surface free energy of each of the electronic material layer and the adhesive material layer satisfies relational expressions (1) and (2) as follows,
E2<E3<E1 or E1<E3<E2 (1)

|E1−E2|>|E3−E2| (2)
where E1 is surface free energy of the bottom of the depression section or the lyophilic part, E2 is the surface free energy of the electronic material layer, and E3 is the surface free energy of the adhesive material layer.

2. The method of producing an electronic member according to claim 1, wherein in the placing of the laminated ink, the laminated ink is formed by disposing the adhesive material layer on the electronic material layer, after the electronic material layer is formed by disposing a liquid electronic material layer at the depression section of the intaglio plate or at the lyophilic part of the lithographic plate, and drying the disposed liquid electronic material layer.

3. The method of producing an electronic member according to claim 2, wherein the liquid electronic material layer is made of a solution containing one or more kinds of material selected from oxide-based transparent conductive material, metal, conductive polymer, and nano-carbon.

4. The method of producing an electronic member according to claim 1, wherein the electronic material layer is a conductive layer or a semiconductor material layer.

5. The method of producing an electronic member according to claim 4, wherein the adhesive material layer is made of an insulating material.

6. The method of producing an electronic member according to claim 4, wherein the electronic material layer and the adhesive material layer have transparency.

7. The method of producing an electronic member according to claim 1, wherein the electronic material layer and the adhesive material layer each have a nanometer-order film thickness.
